(19) United States
(12) Patent Application Publication
(10) Pub. No.: US 2012/0285122 A1
(43) Pub. Date: Nov. 15, 2012

(54) APPARATUS AND METHOD FOR TRANSPORTING AND INSERTING MEANS FOR OPENING/CLOSING THE MOUTH OF BAGS AND A BAG FILLING/SEALING MACHINE

(75) Inventor: Teodoro Concetti, Bastia Umbra (IT)

(73) Assignee: CONCETTI S.P.A., Bastia Umbria (IT)

(21) Appl. No.: 13/468,702

(22) Filed: May 10, 2012

(30) Foreign Application Priority Data
May 11, 2011 (IT) MI2011A 000814

(51) Int. Cl. B31B 1/90; B65B 7/02

(52) U.S. Cl. 53/412; 493/213; 53/139.2

(57) ABSTRACT

An apparatus including a feeding device configured feed a profile in a longitudinal direction, a cutting device configured to cut the profile to form a cut profile section, a gripping device configured to grip and transport the cut profile section, the gripping device being displaceable between a gripping position and a position for introducing the cut profile section into a bag, the gripping device comprising, a pair of grippers to hold the cut profile section, an actuator to move the gripping device in the vertical direction from a position above the bag to a lower position for introducing the cut profile section inside the bag, a moveable guide configured to guide the cut profile section inside the bag, the moveable guide being moveable in the vertical direction between a position above the bag and a position for insertion inside the bag.

### CROSS-REFERENCE TO RELATED ACTIONS

This application claims the benefit of and priority to, Italian Application No. MI2011A 000814, filed on May 11, 2011, which is incorporated by reference herein in its entirety.

### BACKGROUND

It is known that in the technical sector of packaging that there exists the need to introduce into flexible containers such as bags, packets, and the like, products which are not consumed in one sitting and which therefore require the use of a seal to ensure that the package remains intact upon initial opening and with means which, after initial use, allow repeated closing/opening of the bag for subsequent use and maintain the freshness and fragrance of the product.

It is also known that for this purpose bags are manufactured so as to have, applied to their mouth, the opening/closing means which are commonly known by the term “zipper” and essentially consist of two shaped strips of suitable plastic material which are fixed to the mouth of the bag and which, upon displacement of a slider in one direction or the other, close/open with respect to each other. An example of this known art is described for example in U.S. Pat. No. 6,347,437.

Although performing their function, these pre-manufactured bags nevertheless have the drawback that they are made on a production line using complex specially designed machines, thus resulting in an increase in the unit cost per bag. In addition, the pre-manufactured bags with zippers are handled in automatic filling and sealing machines, increasing the risk that damage may occur to the zipper and therefore that the bag may be rejected once filling has been completed. The technical problem which is posed, therefore, is to provide an apparatus for opening/closing the mouth of bags, suitable for being applied to automatic filling machines that are able to ensure production at a higher speed and a reduction in the manufacturing rejects.

### SUMMARY

The present disclosure relates to an apparatus for supplying and inserting means for opening/closing the mouth of bags (e.g., a zipper) and a bag filling/sealing machine provided with the apparatus.

The present disclosure provides the following exemplary embodiment. An apparatus for transporting and inserting zippers (e.g., 1,1a,1b) inside the mouth (e.g., 5a;105a) of bags (e.g., 5;105) in automatic machines for filling and sealing the bags (e.g., 5,105), the zippers comprising a section of a profile (e.g., 1) formed by a flat part (e.g., 1b) and by a shaped male/female head (e.g., 1a), the apparatus comprising: a device (e.g., 10) for feeding the profile (e.g., 1) in a longitudinal direction (e.g., X-X); a device (e.g., 15) for cutting to size the profile (e.g., 1) in the transverse direction (e.g., Y-Y), arranged downstream of the feeding device (e.g., 10); a device (e.g., 20) for gripping/transporting the cut section of the profile (e.g., 1), arranged downstream of the cutter (e.g., 15) and able to be displaced from a gripping station (e.g., S1) to a station (e.g., S2) for introducing the closing/opening means into the mouth (e.g., 5a;105a) of the bag (e.g., 5;105), and vice versa, the gripper (e.g., 20) comprising movement means (e.g., 24) able to move in both senses of the vertical direction (e.g., Z-Z) from a position above the mouth of the bag (e.g., 5;105) to a lower position for introducing the closing/opening means inside the mouth of the bag, the apparatus comprising means (e.g., 300) for guiding the strip section (e.g., 1) for inserting it in the vertical direction (e.g., Z-Z) inside the mouth of the bag, the guide (e.g., 300) being movable in the vertical direction (e.g., Z-Z) from a position above the mouth (e.g., 5a) of the bag (e.g., 5) into a position for insertion inside the mouth and vice versa. A filling machine provided with the apparatus and a method for applying a zipper to the bag mouth.

In connection with the problems identified above, it is also desired that the apparatus should have small dimensions, be easy and inexpensive to produce and assemble and be able to be installed easily on already existing machines without the need for excessive adaptation. These results can be achieved according to the present disclosure by an apparatus for applying a zipper to the mouth of bags in automatic machines for filling and sealing the bags according to the characteristic features recited in the respective claims.

These and other capabilities of the invention, along with the invention itself, will be more fully understood after a review of the following figures, detailed description, and claims.

### BRIEF DESCRIPTION OF THE FIGURES

Further details may be obtained from the following description of a non-limiting example of the claimed subject matter, with reference to the accompanying drawings in which:

FIG. 1: shows a front view of a first example of an embodiment of an apparatus for transporting a bag mouth closing/opening means;

FIG. 2: shows a partial schematic view of the detail of a gripper of the apparatus;

FIG. 3: shows a partial schematic cross-section along the plane indicated by the line III-III in FIG. 2;

FIG. 4a: shows a schematic front view of the detail of a gripper for gripping the zipper and a guide for correct insertion of the zipper inside the mouth of the bag;

FIG. 4b: shows a top plan view of the mouth of the bag during the opening step prior to insertion of the zipper;

FIG. 5a: shows a schematic front view of the apparatus with the guide inserted and widened in the position for entry of the zipper;

FIGS. 5b,5c: show respective schematic top plan views of the bag mouth with the guide inserted and widened into the position for entry of the zipper;

FIGS. 6-11: show schematic top plan and side views of the station for applying the zipper during the successive working steps;

FIGS. 12a,12b: show side views of a second embodiment of the means for opening/welding the zipper and the zipper applied to a bag via the means;

FIGS. 13,14: show schematic top plan views illustrating opening of the mouth and insertion of the zipper guide for a pleated bag;

FIGS. 15a,15b: show, respectively, a perspective and side view, which are partial and schematic, of a second example of embodiment of the apparatus according to the present invention;

FIGS. 16a,16b: show views similar to those of FIGS. 15a,15b of the machine with the gripper moved into position at the zipper application station and guides inserted inside the bag mouth;

FIG. 17: shows a partial, schematic side view of the apparatus during entry of the zipper inside the bag mouth; and

FIG. 18: shows a variation of an example of embodiment of the machine according to FIG. 15 for simultaneous application of two zippers to the respective bag.

### DETAILED DESCRIPTION

As shown in the figures and assuming solely for the sake of convenience of the description and without any limitation of meaning, a set of three reference axes in a longitudinal direction X-X, corresponding to the direction of an orientation of a larger dimension of a bag mouth, a transverse direction Y-Y perpendicular to the preceding direction, and a vertical direction Z-Z, respectively.

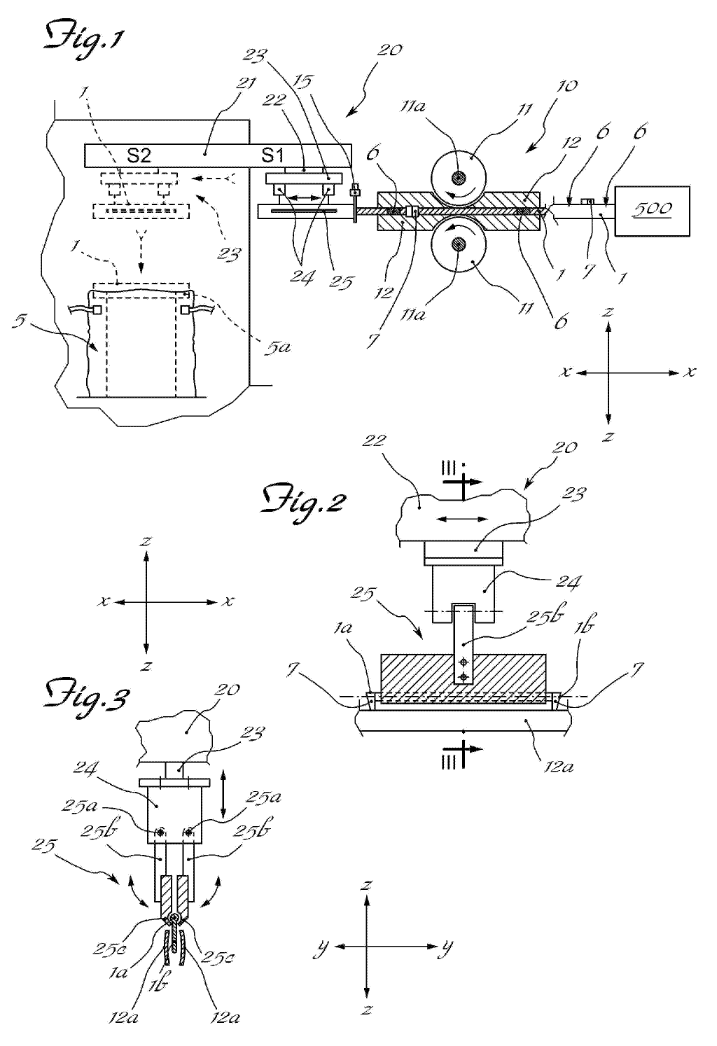

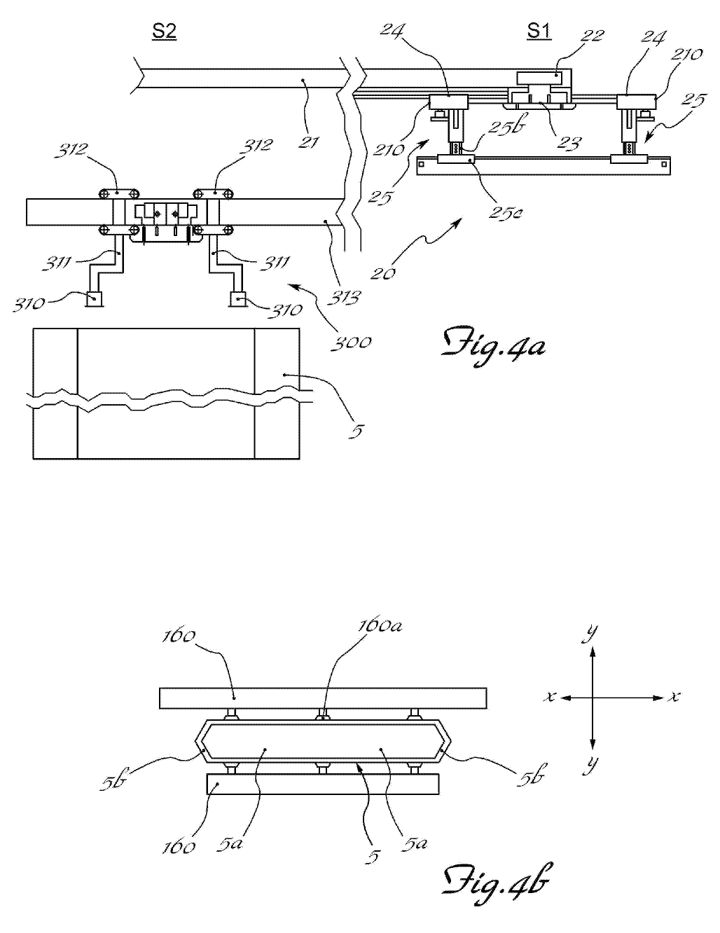

Referring to FIGS. 1-3, an apparatus for transporting closing/opening means (also referred to herein as a “zipper”) to mouths 5a of bags 5 includes a device 10 for feeding a profile 1 from a continuous strip supplied by a forming machine schematically indicated by 500. The profile 1 can be conventional with two parallel strips formed as a shaped male/female head 1a for relative engagement/disengagement in the transverse direction and a flat bottom part 1b for joining to the opposite lips of the mouth 5a of the bag 5. In some embodiments, the profile 1 supplied from the machine 500 can be provided with at least one slider 6 for opening/closing the zipper and a pair of end-of-travel stops 7 for the slider arranged on opposite sides of the latter. The profile 1 forms a so-called “zipper” for repeated closing/opening of the bag mouth.

The feeding device 10 includes a pair of rollers 11 which can be respectively rotationally driven by a shaft 11a, which can be operated by a motor (not shown). The motor can include a device for measuring the revolutions of the rollers such that the length of the profile section 1 being fed by the rollers 11 can be determined. For example, an encoder can be used to calculate the number of revolutions of the rollers 11 and/or a photocell can be used to detect markings on the profile 1 or the shaft 11 such that the length of the profile 1 fed by the rollers 11 can be determined. During transportation via the rollers 11, the profile 1 can be made to pass through a guide 12 and a pair of longitudinal belts 12a so as to keep it stably parallel to the vertical direction Z-Z.

A cutting device 15 for cutting the profile 1 can be arranged downstream of the device 10 for feeding the profile 1. The cutting device 15 can be configured to cut, to a predefined size, a strip section 1 comprising both the slider 6 and the end-of-travel stops 7 if present. Preferably, the cutting device 15 includes a cutting implement such as a knife, blade, or electronic cutting means (e.g., thermal), that is configured to cut the profile 1 without damaging it.

A gripping device 20 (e.g., the gripper) for gripping and transporting the profile section 1, which has been cut to size by the cutter, can include a linear guide 21, which can be situated parallel to the longitudinal direction X-X. Disposed on the linear guide 21 can be a sliding shoe 22 of a carriage 23, which is movable. The carriage 23 having fastened thereto two actuators 24 of a gripper 25, the arms 25b of which have a first end hinged at 25a on the actuator 24 and a free gripping end 25c, suitably shaped, for engagement with the shaped head 1a of the profile 1. The actuators 24 can also be configured to move not only in both senses of the longitudinal direction X-X so as to adapt their interaxial distance to the length of the zipper to be applied, but also in the two senses of the vertical direction Z-Z for entry into/exit from the bag mouth.

It is envisaged that a tensioning means 200 may be provided at the point where each actuator 24 is attached to the carriage 23. The tensioning means 200 can include a slider 210, which can be controlled and designed to impart to the grippers 25 small displacements in the longitudinal direction X-X so as to produce suitable tensioning of the zipper and keep it as flat as possible for correct insertion inside the bag mouth.

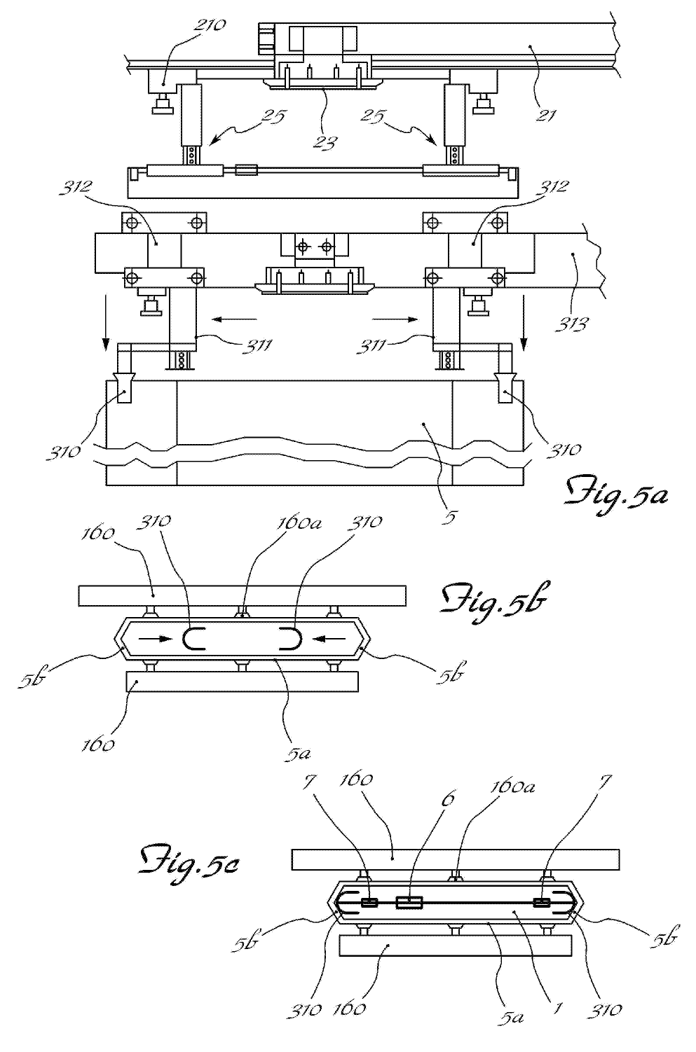

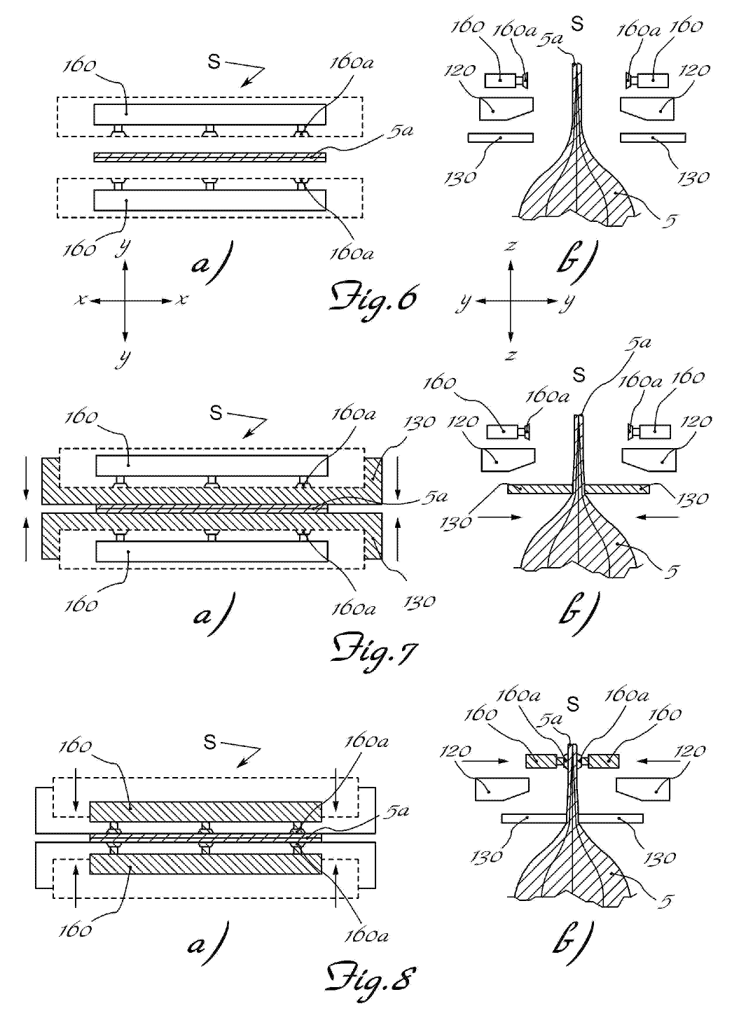

Referring also to FIGS. 4a to 5c, a guide device 300 for guiding the zipper during its entry into the mouth 5a of the bag 5 is shown. The guide 300 can include a pair of substantially C-shaped elements 310 arranged opposite each other in the longitudinal direction X-X so as to have their concavity directed towards the opposite ends of the zipper and respectively connected to an arm 311 attached to a sliding member 312 movable on a horizontal fixed guide 313 arranged underneath the gripper 25 in the vertical direction Z-Z. Each slide 312 can be displaced in the two senses of the longitudinal direction X-X by controlled drives which are conventional per se and not shown.

With the foregoing configuration, an exemplary operating method of the apparatus can be as follows. A profile 1 in strip form together with, if desired, sliders 6 and end-of-travel stops 7 is fed from the machine 500 and the free end thereof is conveyed to the entrance of the guide 12 and between the feed rollers 11 and belts 12a. The motor for the rollers 11 can be activated so as to determine, via corresponding control means, such as an encoder, photocells for detecting markings on the strip 1, or the like, a number of revolutions of the rollers 11 such that a profile section 1 of suitable length is brought into the vicinity of the grippers 25, which will be closed around the profile. A suitable enable signal can cause operation of the cutting device 15 to cut a measured section of the profile 1. If present, the tensioning means 200 for imparting the correct tension to the strip section 1 held by the grippers 20 can be activated. The cutting of the profile 1 can start the displacement of the carriage 23 from a gripping station S1 to a zipper application station S2 where the carriage 23 positions the cut profile such that it is aligned with a mouth 5a of a bag 5 arriving at the same station S2 from the transverse direction Y-Y. At the zipper application station S2 (e.g., FIGS. 5a, 5b) the mouth 5a of the bag can be opened and the C-shaped guide elements 310 can then be lowered in the direction Z-Z so as to enter in a position close to each other, being arranged centred relative to the vertical axis of symmetry Z-Z of the closing bag 5.

Once the C-shaped guide elements 310 have entered into the mouth of the bag, the C-shaped guides 310 are displaced in the opposite senses of the longitudinal direction X-X (e.g., FIG. 5c) until the respective side edges 5b of the bag are reached. Once the guides 310 are arranged in the end position, the downward movement of the grippers 25 can be activated so that the profile 1 enters into the mouth 5a of the bag in the correct position, guided by the opposite C-shaped elements (e.g., FIG. 5c). The C-shaped guide elements 310 can be extracted from the mouth of the bag where the zipper is welded to the opposite lips of the mouth via corresponding welding means (not shown) of the machine.

It is therefore clear how, with the apparatus according to the present disclosure, it can be possible to prepare rapidly and at a low cost, profile sections 1 of given size for opening/closing the mouth of bags and transport the sections to the bag sealing station for insertion inside the bag mouth. In addition, the possibility of using electronic devices for measuring the length of the profile section 1 to be cut can allow variation, in a simple manner, by means of programmable control devices arranged along the line, of the length of the profile section when there is a variation in the longitudinal dimensions of the bag mouth.

The present disclosure also relates to a bag filling and sealing machine that includes an apparatus for transporting means for opening/closing the bag mouth.

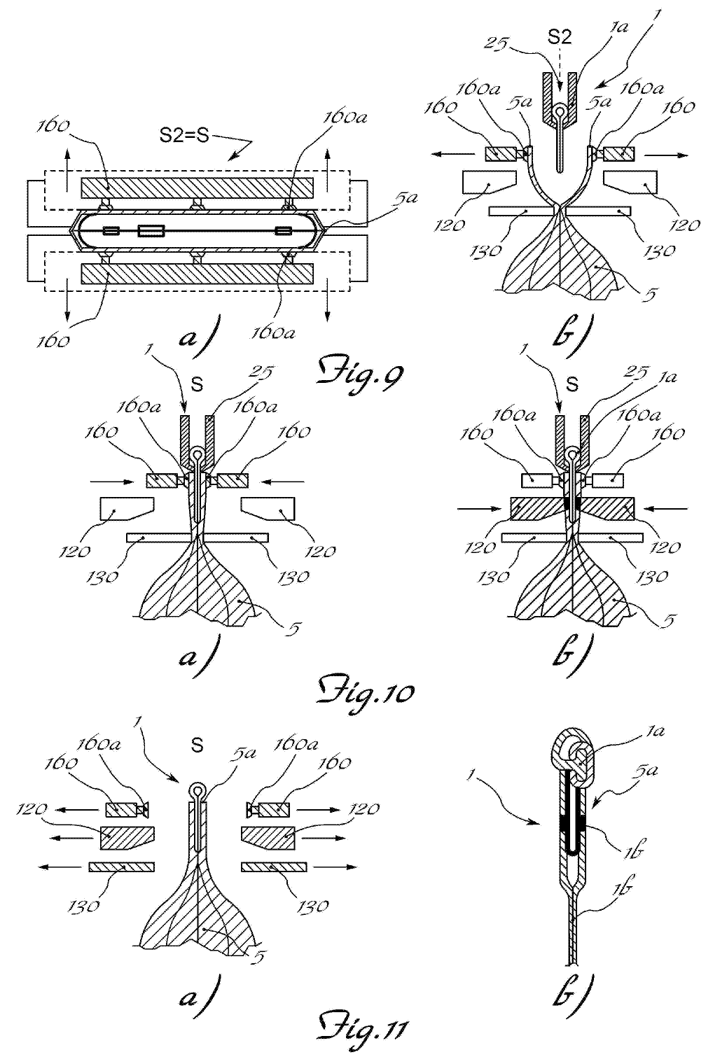

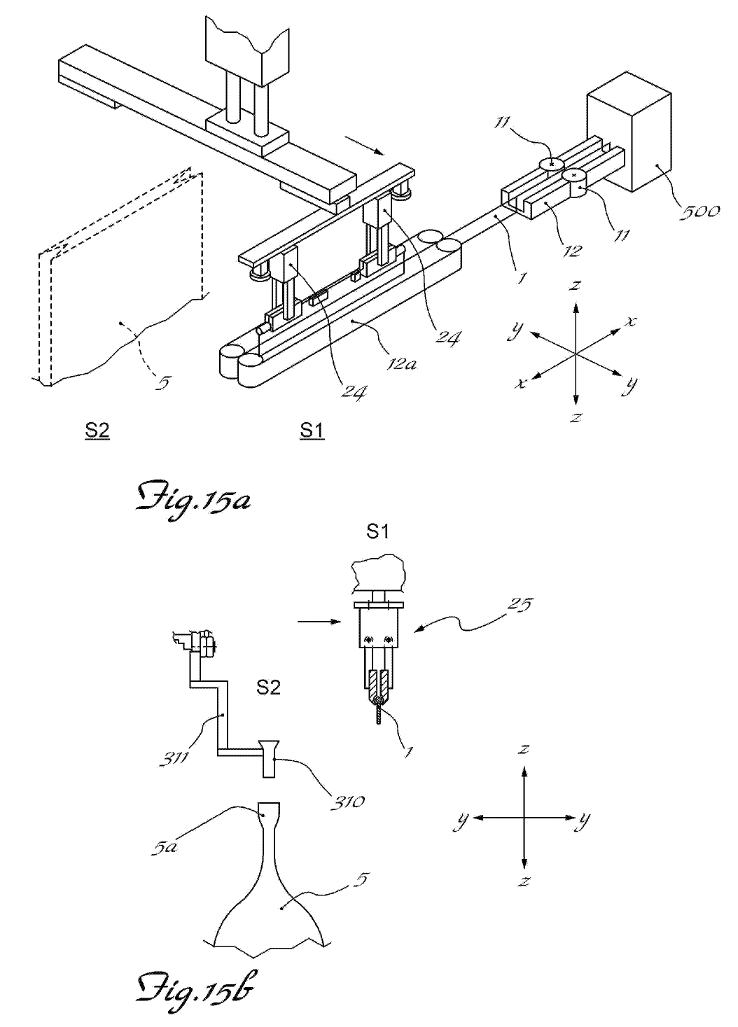

In detail and with reference to FIGS. 6 to 11 the machine includes a sealing station S comprising arms 160 with suction cups 160a arranged on opposite sides of the lips of the mouth 5a of the bag 5. The arms suction-cup 160 can be displaced symmetrically in the transverse direction Y-Y towards/away from said lips in order to adhere to them and cause relative gripping/opening/closing. Welding bars 120 can be arranged in the vertical direction Z-Z underneath the suction-cup gripping arms (e.g., FIG. 6b), the bars being, in turn, arranged symmetrically on opposite sides of the bag mouth in the transverse direction Y-Y and being able to be displaced towards/away from the latter. A pair of pressers 130 can be present below the welding means 120 in the vertical direction Z-Z, being symmetrically arranged on opposite sides of the bag mouth and being able to be displaced towards/away from the mouth in the transverse direction Y-Y.

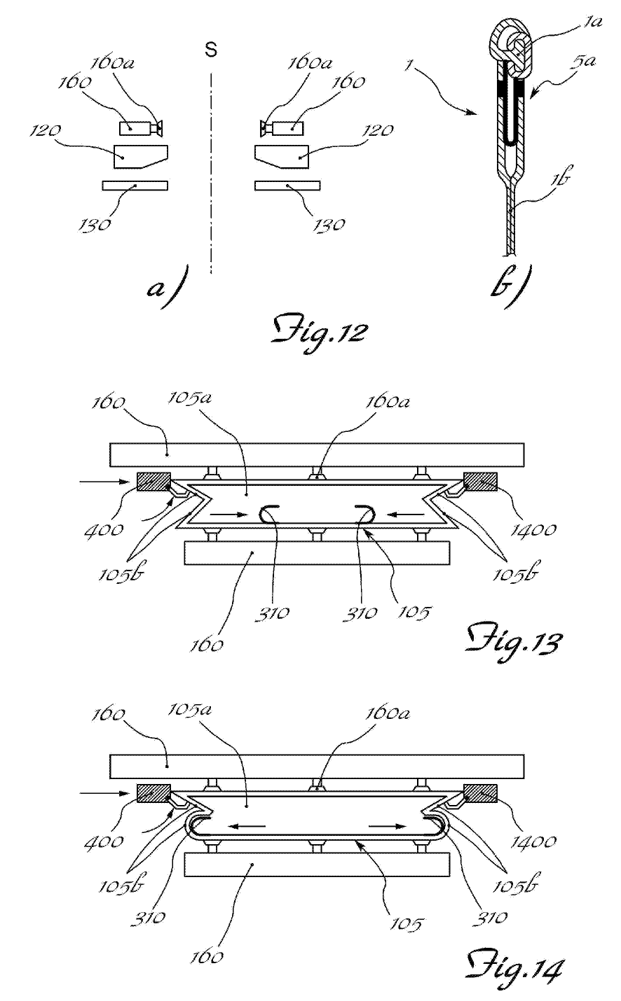

With this configuration, an exemplary operating method of the machine can be as follows. The profile section 1 can be prepared, e.g., measured and cut to size, with, if necessary, the slider 6 already mounted. The profile section can be conveyed to the station S2 of the apparatus arranged in the machine sealing station S by means of the carriage 23 of the apparatus. Being moved along a longitudinal path X-X, and at the same time the filled bag 5 is also conveyed in a transverse direction Y-Y to the sealing station S. The pressers 130 are closed so as to close the bag 5 at a predetermined distance from its mouth 5a in the vertical direction Z-Z. The arms 160 with suction cups 160a are operated so as to close onto the bag mouth (e.g., FIG. 8) and the same arms 160 can be operated in the reverse sequence (e.g., FIG. 9) so as to perform stable opening of the bag mouth 5a. The guide 310 can be lowered into the mouth 5a of the bag and widened according to the size of the mouth 5a itself. The grippers 25 of the apparatus can be lowered in the vertical direction Z-Z until the profile 1, guided by the C-shaped elements, is brought into the correct position inside the mouth 5a, so that only the shaped head part 1a remains outside of it. The guides 310 can then be extracted. The welding bars 120 can be closed so as to join the flat part 1b of the strips 1 to the respective lips of the mouth 5a of the bag 5. The arms 160 with the suction cups 160a and the pressers 130 can then be opened again. The grippers 25 can be repositioned at the station S1 so as to pick up a new zipper and start another cycle.

It can therefore be seen how, owing to interaction with the apparatus for cutting, transporting and inserting the bag mouth closing/opening means, arranged downstream of the filling station and provided with means for guiding the zipper, an automatic filling and sealing machine is able to produce at high speed and at a low cost filled and sealed bags provided with the bag mouth closing/opening means.

Although not shown, it is also envisaged that the automatic machine may be of the FFS (Forming/Filling/Sealing) type in which the bag is formed from a continuous tubular element or of the type in which the bag is pre-formed externally to the machine and supplied to the station for filling the bag, via automatic movement means.

FIGS. 12a and 12b show a variation of embodiment of the welding means which envisages relative inversion in the vertical direction Z-Z of the suction cups 160 with the welding grippers 120, it thus being possible to obtain a welding line which is much closer to the bag mouth and to the zipper slider, with improved application from an aesthetic point of view.

As shown in FIGS. 13 and 14, it is also envisaged that the machine can allow application of the zipper also inside the mouth 105a of pleated bags 105.

In this case preferably gripper means 400 or blower means 1400 acting on the portions 105b of the pleat are preferably provided in order to facilitate entry of the zipper in the correct position for welding to the portions of the bag.

In greater detail and still with reference to the cited FIGS. 13 and 14, the gripper means 400 and blower means 1400 can be arranged on only one of the two arms 160 supporting the suction cups 160a and on the outside of the bag 105 in the longitudinal direction X-X. The gripper means 400 and blower means 1400 can be movable in both senses of the longitudinal direction X-X so as to be able to be correctly positioned in the vicinity of the portions 105b of the pleat upon variation in the width dimension, in the longitudinal direction, of the mouth 105a of the bag 105.

In this configuration the grippers/blowers can act symmetrically on one half of the pleat 105b so as to close it in the transverse direction Y-Y and keep open the other half of the pleat into which the guide 310 are vertically introduced. The grippers/blowers, once they have been symmetrically moved away in the longitudinal direction towards the respective end of the bag without deforming the pleat portions 105b not retained in the transverse direction Y-Y by the gripper means 400 and blower means 1400, from this condition the zipper insertion sequence already described can be recommenced.

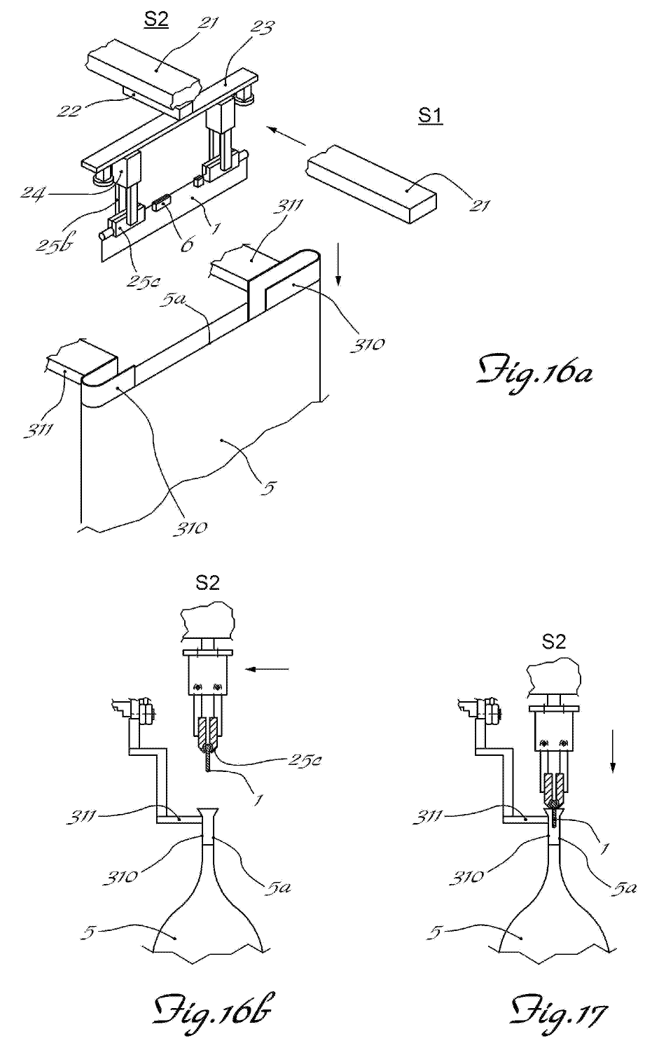

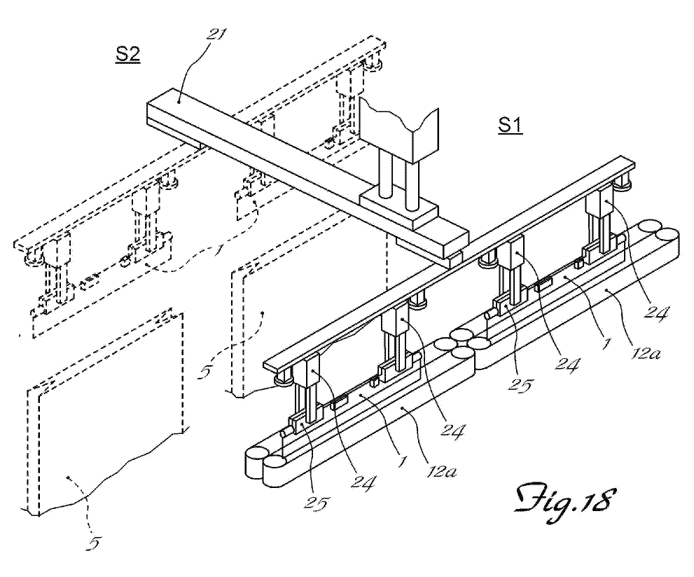

As shown in FIGS. 15a and 15b a further embodiment of the bag filling machine is also envisaged where the grippers 25 move in the transverse direction Y-Y (and not the longitudinal direction X-X) so as to convey the zipper from the gripping station 51 to the station S2 for applying the zipper to the mouth 5a of the bag 5. In other words, while in the first embodiment (e.g., FIG. 1) the movement of the gripper 25 occurs parallel to the direction of the greater dimension of the mouth of the bag 5, in the second embodiment the movement of the gripper 25 occurs at right angles to the longitudinal direction X-X of the greater dimension of the mouth 5a of the bag 5. As shown in FIGS. 16a, 16b and 17 the sequence for insertion of the guides 310 and the zipper 1 can remain the same.

Furthermore, in some embodiments, it is also envisaged that the grippers 25 can move in both the longitudinal X-X direction and the transverse direction Y-Y simultaneously.

In addition, with an embodiment shown in FIG. 18, it is also possible to double the apparatus in the longitudinal direction X-X so as to apply simultaneously a zipper to two bags conveyed by the machine in the direction X-X.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. An apparatus comprising:
a feeding device configured feed a profile in a longitudinal direction (X-X);
a cutter for receiving the profile, the cutter configured to cut the profile in a transverse direction (Y-Y) to form a cut profile section;
a gripper assembly configured to grip and transport the cut profile section, the gripper assembly being moveable between a gripping position and a position for introducing the cut profile section into a mouth of a bag, the gripping device including:
a pair of grippers configured to hold the cut profile section;
an actuator configured to move the gripper assembly in the vertical direction (Z-Z) from a position above the mouth of the bag to a lower position for introducing the cut profile section inside the mouth of the bag;
a moveable guide configured to guide the cut profile section inside the mouth of the bag, the moveable guide being moveable in the vertical direction (Z-Z) between a position above the mouth of the bag and a position for insertion inside the mouth of the bag.

2. An apparatus according to claim 1, wherein the moveable guide is displaceable in both senses of the longitudinal direction (X-X) from an entry/exit position close together into a position distant from each other in the longitudinal direction.

3. An apparatus according to claim 1, wherein the moveable guide includes a pair of substantially C-shaped members arranged opposite each other in the longitudinal direction (X-X) and each connected to an arm attached to a slide movable on a horizontal fixed guide disposed arranged underneath the gripping device in the vertical direction (Z-Z).

4. An apparatus according to claim 3, wherein each slide is displaced in both senses of the longitudinal direction (X-X) by controlled drives.

5. An apparatus according to claim 1, wherein the feeding device includes a pair of rollers that are respectively rotationally driven by a shaft, the shaft being operated by a motor including a sensor for measuring a length of the cut profile section.

6. An apparatus according to claim 1, wherein the feeding device includes a linear guide extending in the longitudinal direction (X-X) and a pair of belts (12a) aligned in the same longitudinal direction for stably keeping the profile parallel to the vertical direction (Z-Z).

7. An apparatus according to claim 1, wherein the gripper assembly includes a linear guide, a carriage movable in both senses of the linear guide, two actuators that are attached to the carriage and able to move in both senses of the vertical direction (Z-Z) and which carry the pair of grippers.

8. An apparatus according to claim 7, wherein the pair of grippers includes arms, a first end of which is hinged with the respective actuator and a second end of which is free and shaped in a manner corresponding to a shaped head of the profile.

9. An apparatus according to claim 1, wherein the gripper assembly is configured to grip at least one slider mounted on the cut profile section.

10. An apparatus according to claim 1, further comprising tensioning means including a slider that is controlled and able to impart to the pair of grippers small displacements in the longitudinal direction (X-X).

11. An automatic machine for filling and sealing bags having a mouth including lips, the machine comprising at least one filling station and a sealing station for the bags, the automatic machine comprising an apparatus according to claim 1 arranged downstream of the filling station and in communication with the sealing station.

12. A machine according to claim 11, wherein the sealing station comprises:
arms arranged on opposite sides of the lips of the mouth of the bag in the transverse direction (Y-Y);
suction cups disposed on the arms;
the arms being configured to move symmetrically in the transverse direction (Y-Y) towards and away from the lips so as to adhere to them and cause relative gripping, opening, and closing thereof;
welding bars arranged symmetrically on opposite sides of the mouth of the bag in the transverse direction (Y-Y) and able to move towards and away from the bag;
a pair of pressers that are disposed underneath the welding means (120) in the vertical direction (Z-Z) and symmetrically on the opposite sides of the bag mouth in the transverse direction (Y-Y) and are able to move towards and away from the latter.

13. A machine according to claim 12, where the arms are disposed below the welding bars in the vertical direction (Z-Z).

14. A machine according to claim 12, wherein the arms are disposed above the welding bars in the vertical direction (Z-Z).

15. A machine according to claim 11, wherein the machine is configured to work with a pleated bag.

16. A machine according to claim 15, further comprising means arranged outside of side portions of the bag in the longitudinal direction (X-X) and movable in both senses of the longitudinal direction (X-X) for correct positioning in proximity of portions of the pleat upon variation in the longitudinal dimension of the mouth of the bag and able to act symmetrically on one half of the pleat so as to close the same in the transverse direction (Y-Y) and keep an other half of the pleat open.

17. An apparatus according to claim 1, wherein at least a portion of the gripper assembly is displaceable parallel to the longitudinal direction (X-X) of the greater dimension of the mouth of the bag.

18. An apparatus according to claim 1, wherein at least a portion of the gripper assembly is displaceable at right angles to the longitudinal direction (X-X) of the greater dimension of the mouth of the bag.

19. An apparatus machine according to claim 18, further comprising a double gripper assembly arranged in-line in the longitudinal direction (X-X).

20. A method for applying zippers of bags in automatic filling machines according to claim 11, wherein the automatic filling machine includes a gripper assembly including a pair of grippers configured to hold the cut profile section, an actuator configured to move the gripping device in the vertical direction (Z-Z) from a position above the mouth of the bag to a lower position for introducing the cut profile section inside the mouth of the bag, and a moveable guide configured to guide the cut profile section inside the mouth of the bag, the moveable guide being moveable in the vertical direction (Z-Z) between a position above the mouth of the bag and a position for insertion inside the mouth of the bag, the method comprising:
filling bags; and
applying the zippers.

21. A method according to claim 20, wherein the applying includes:
introducing, in the vertical direction (Z-Z), inside the mouth of the bag, a guide arranged in a relative position close to each other in the longitudinal direction (X-X); and
opening the guide as far as the side portions of the bag mouth prior to the step of introducing the bag mouth opening/closing means in the vertical direction (Z-Z).
